(19) United States
(12) Patent Application Publication
(10) Pub. No.: US 2014/0216066 A1
(43) Pub. Date: Aug. 7, 2014

(54) Dynamic Ullage Control System for a Cryogenic Storage Tank

(71) Applicant: HEBELER CORPORATION, Tonawanda, NY (US)

(72) Inventors: Kenneth Leo Snyder, Hamburg, NY (US); Robert Francis Desjardins, Boston, NY (US)

(73) Assignee: HEBELER CORPORATION, Tonawanda, NY (US)

(21) Appl. No.: 13/758,290

(22) Filed: Feb. 4, 2013

(51) Int. Cl. F17C 13/02

(52) U.S. Cl. CPC F17C 13/021
USPC 62/49.2

(57) ABSTRACT

A dynamic system for determining an optimal liquid fill level and ullage space for a cryogenic liquid storage tank based on the temperature of the liquid being dispensed into the tank, and the desired operating pressure for an application. A means for selecting a desired operating pressure, such as a dial, is located external to the storage tank. A temperature sensor measures the temperature of the cryogenic liquid being dispensed. An optimal fill level and ullage space is calculated, and communicated to a liquid level sensor and flow control valve.

### BACKGROUND

This disclosure relates generally to a system for controlling the ullage space in a cryogenic storage tank. More particularly, a dynamic system which determines an optimal liquid fill level based on the temperature of the liquid being dispensed, and the desired operating pressure of an application.

For the purpose of this application, cryogenic liquids include liquefied gases that boil at temperatures at or below −150° F. under normal atmospheric pressure. LNG is one example of a cryogenic liquid because it boils at −258° F. under normal atmospheric pressure. Because of this, most cryogenic storage tanks are of a double wall construction. An inner pressure vessel is typically supported within an outer vessel. Radiation shielding is usually placed in the space between the inner and outer vessels, and the space is placed under a high vacuum to provide effective insulation against heat transfer.

A concern with any cryogenic storage tank is that there may be excess heat transfer or “heat leak,” thereby reducing the holding time of the cryogenic liquid. Heat leak is a concern because as the liquid heats up, its saturated pressure increases and it expands, which increases the pressure within the storage tank. Once the pressure in the storage tank becomes too high, a pressure relief valve will typically open, releasing a portion of the tank's contents into the atmosphere or to a recovery system. “Holding time” describes the time span that a cryogenic liquid can be held inside a storage tank before the pressure relief valve opens. Because high heat leak leads to shorter holding times, heat leak in a storage tank will result in venting off a substantial portion of gaseous cryogenic material if the tank is required to hold the liquid for any appreciable amount of time. For example, if a storage tank used to store LNG fuel for use in a vehicle, any natural gas that is vented off because of heat leak is fuel that was paid for by the operator but never used, increasing cost. It is therefore important for storage tanks to have relatively long holding times. Cryogenic storage tanks with low heat leak and relatively long holding times are said to have good “thermal performance.”

One way of increasing thermal performance is to reserve a portion of the space within the storage tank for vapor when the storage tank is filled. This vapor space is known as “ullage space,” and it provides a volume for cryogenic liquid to boil and expand into so that the pressure in the tank does not increase to a point where the relief valve would open. If a storage tank is filled completely with cryogenic liquid, without reserving an ullage space, even a very small amount of heat leak could cause a rapid increase in pressure, because there would be no space into which the cryogenic liquid could boil or expand. Accordingly, it is common practice when filling a cryogenic storage tank to reserve an ullage space.

There are several methods for reserving an ullage space in a cryogenic storage tank. The first method is to partition the ullage space from the liquid space so that when filling the storage tank, the ullage space remains primarily empty. Another method is to use an auxiliary tank, which can act as an ullage space for a main cryogenic storage tank. Still another method is the use of a tubular elbow welded to the end of a vent line in the interior of the tank in a position perpendicular to the liquid surface of the cryogenic liquid. The downward end of the tubular facing elbow has an opening whereby vapor can be conducted out of the tank and the fill level is established.

A common problem with each of these methods is that the ullage space is fixed, regardless of temperature and saturated pressure of the cryogenic liquid being dispensed into the storage tank. Saturated pressure is the pressure exerted by a vapor in thermodynamic equilibrium with its condensed phases at a given temperature in a closed system. The saturated pressure of any substance increases non-linearly with temperature. Thus, cryogenic liquid with an elevated saturated pressure is created by elevating the temperature of cryogenic liquid. This “warmed” cryogenic liquid, with an elevated saturated pressure is known as “conditioned liquid.” Conversely, “unconditioned liquid” has a relatively low saturated temperature and saturated pressure to conditioned liquid. Raising the saturated pressure and temperature of a cryogenic liquid, or “conditioning the liquid,” also causes the liquid to expand and become less dense. Because some applications require conditioned liquid, it is common to either dispense conditioned liquid into a cryogenic storage tank, or condition the liquid after it has been dispensed. Therefore, if unconditioned liquid is dispensed, and conditioned in the storage tank, it will require a relatively larger reserved ullage space since it will expand a great deal more than conditioned liquid.

Further, applications requiring cryogenic liquid may require the liquid to be saturated at different operating pressures. For example, a vehicular engine powered by LNG may require an operating pressure of 120 pounds per square inch (psi). If unconditioned LNG is dispensed into the vehicle's storage tank at 20 psi, the liquid would need to be conditioned and expand before it could power the vehicle. This would require a relatively large ullage space to be reserved. If the reserved ullage space were too small, this would cause significant heat leak and a loss of valuable cryogenic material. However, if conditioned LNG is dispensed into the vehicle's storage tank at 100 psi, the liquid would not need to be conditioned or expand, and only a relatively small ullage space would need to be reserved. If the reserved ullage space were too large, the vehicle operator would be unable to fill the storage tank to its full capacity.

Historically there are no dynamic ullage control systems for cryogenic storage tanks. It is therefore desirable to provide a system that can control the ullage space in a cryogenic storage tank based on the pressure of the liquid being dispensed, and the pressure required by an application.

### SUMMARY OF THE INVENTION

According to the present disclosure, the foregoing and other objects and advantages are attained by a system for dynamic ullage control within a cryogenic storage tank.

The system includes at least one storage tank capable of receiving cryogenic liquid through a fill line at an initial pressure. A temperature sensor is used to determine the initial temperature of the cryogenic liquid being dispensed, such as a thermocouple. The temperature sensor may located in the fill line to the storage tank, or in the dispensing system. A flow control valve is also located in the fill line to the storage tank or in the dispensing system. A liquid level sensor capable of measuring the cryogenic liquid depth inside the storage tank, such as a capacitance probe is located within the storage tank. A means for selecting a desired operating pressure, such as a dial, is located external to the storage tank.

A desired operating pressure for cryogenic liquid is selected based on an application. The desired operating temperature of the liquid is then easily calculated because temperature of a specific liquid is a function only of its saturated pressure. When cryogenic liquid is dispensed into the storage tank, the temperature sensor determines the initial temperature of the cryogenic liquid. The initial temperature of the cryogenic liquid being dispensed and the selected desired operating pressure will be used to calculate an optimal fill level and ullage space based on the liquid's expected expansion. The liquid level sensor will measure the liquid depth of the cryogenic liquid in the storage tank. When the liquid reaches the calculated optimal fill level, the liquid level sensor will communicate with the flow control valve, and flow into the storage tank will be stopped.

It is therefore an advantage of the present disclosure to provide a system for controlling the ullage space in a cryogenic storage tank.

It is another advantage of the present disclosure to a dynamic system which determines an optimal fill level and ullage space in a cryogenic storage tank based on the initial temperature of the liquid and the desired operating pressure of an application.

Additional objects, advantages and novel features of the disclosure will be set forth in part in the description which follows, and in part will become apparent to those skilled in the art upon examination of the following or may be learned by practice of the disclosure. The objects and advantages of the disclosure may be realized and attained by means of the instrumentalities and combinations particularly pointed out in the appended claims.

### BRIEF DESCRIPTION OF THE DRAWINGS

FIG. 1 is a schematic view of an ullage control system for a cryogenic storage tank in accordance with a preferred embodiment of this disclosure.

FIG. 2 is a schematic view of an ullage control system for a cryogenic storage tank in accordance with a preferred embodiment of this disclosure.

FIG. 3 is a block diagram for liquid pressure, depth and expansion calculations.

Reference will now be made to the exemplary embodiments illustrated, and specific language will be used herein to describe the same. It will nevertheless be understood that no limitation of the scope of the disclosure is thereby intended.

### DETAILED DESCRIPTION OF PREFERRED EMBODIMENT(S)

Throughout the following description specific details are set forth in order to provide a more thorough understanding of the disclosure. However, the disclosure may be practiced without these particulars. In other instances, well known elements have not been showed or described in detail to avoid unnecessarily obscuring the present disclosure. Accordingly, the specification and drawings are to be regarded in an illustrative, rather than restrictive sense.

Generally, the subject disclosure relates to a system for controlling the ullage space in a cryogenic storage tank. More particularly, a dynamic system which calculates an optimal fill level and ullage space in a cryogenic storage tank based on the initial temperature of the liquid being dispensed, and the desired operating pressure of an application.

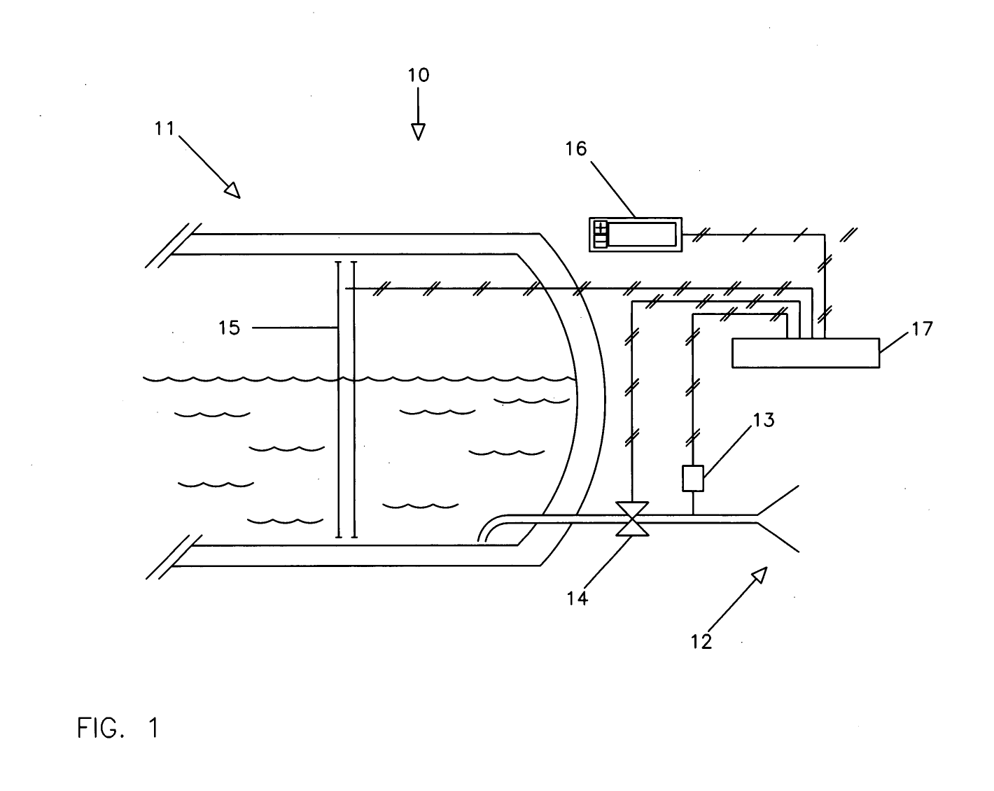

As illustrated in FIG. 1, a system for controlling the ullage space in a cryogenic storage tank, indicated generally at 10, is shown in an example implementation in accordance with the disclosure. The system includes at least one cryogenic storage tank 11 capable of receiving cryogenic liquid through a liquid fill line 12. Typically, the tank 11 will be a vacuum insulated cryogenic storage tank designed to contain cryogenic liquid such as liquefied natural gas. The system utilizes a temperature sensor 13 capable of measuring the temperature of a cryogenic liquid, such as a thermocouple, for determining the initial temperature of the liquid being dispensed. This sensor measures the initial temperature of cryogenic liquid dispensed into the storage tank 11. A flow control valve 14 is located in the fill line 12. A liquid level sensor 15, such as a capacitance probe, is located inside the storage tank. A means for selecting a desired operating pressure 16, such as a dial, is located external to the storage tank. The initial temperature of liquid being dispensed into the storage tank, and the desired operating pressure are used to calculate the optimal fill level and ullage space through a control box 17. The liquid level sensor 15 communicates when the optimal fill level has been reached, and the flow control valve 14 closes, stopping flow into the storage tank. The liquid level sensor, temperature sensor and means for selecting a desired operating pressure can communicate with the control box 17 and flow control valve 14 in any way, including a programmable logic controller, mechanical relays, or solid state relays. For clarity, other devices commonly installed on cryogenic storage tanks such as pressure safety valves, and liquid or vapor circuits are not displayed in FIG. 1 because they are immaterial to the operation of the disclosure.

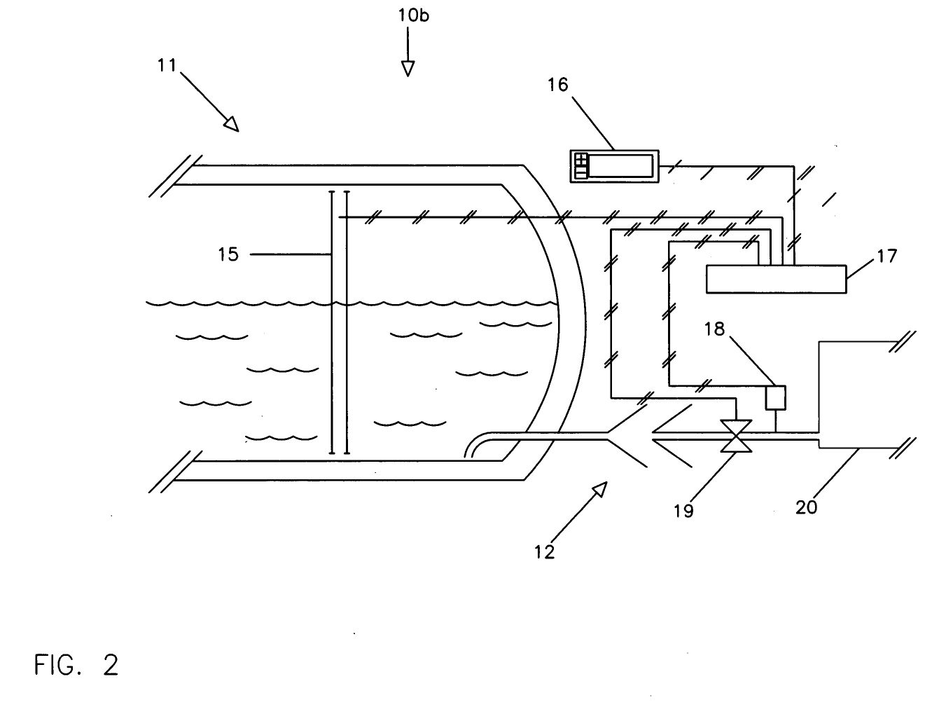

Referring to FIG. 2, another system 10b is shown that is similar in most respects to that described above, but where the means for determining the temperature 18 of the cryogenic liquid and flow control valve 19 are located within a dispensing system 20, rather than the fill line of the storage tank.

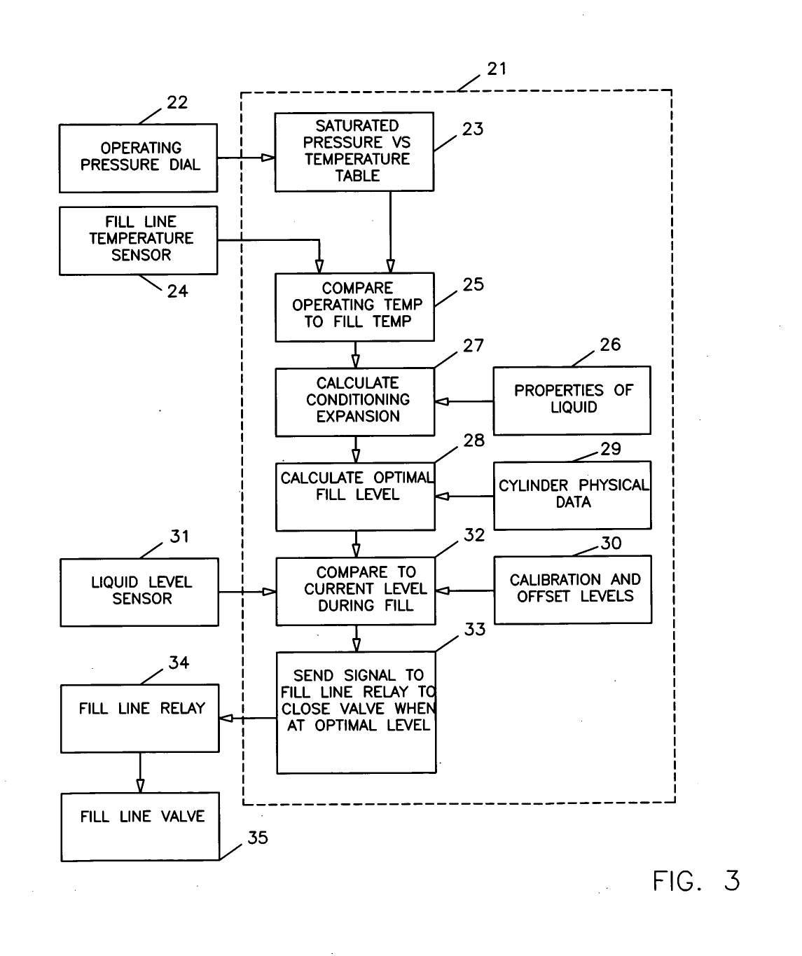

FIG. 3 is a block diagram of the operation of a system for controlling the fill level and ullage space in a cryogenic storage tank in accordance with the present disclosure. The optimal fill level and ullage space calculations are determined by the control box, indicated generally at 21. The desired operating pressure is selected using a means such as a dial 22. The desired operating pressure is then input to a saturated pressure and temperature table 23, where the corresponding desired operating temperature of the cryogenic liquid is determined. This is easily calculated because the saturated pressure of a specific liquid is a function only of the temperature of the liquid. This calculation is compared 25 with the initial temperature of the cryogenic liquid, as measured by the temperature sensor 24. This comparison 25 is used, in combination with the properties of the cryogenic liquid 26, to calculate the expansion of the liquid inside the storage tank 27. This calculation is used, in combination with the physical properties of the storage tank 29 to calculate the optimal fill level 28 and ullage space. This calculation is then used in combination with any calibration and offset levels 30 and the liquid level sensor 31 to compare the optimal fill level to the current fill level 32. When the optimal fill level is reached, a signal 33 is sent to a relay to close the flow control valve. The relay 34 then closes the flow control valve 35.

While the foregoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

What is claimed is:

1. A system for controlling the ullage space of a cryogenic storage tank comprising:
a) at least one insulated storage tank capable of receiving and storing a liquid at a cryogenic temperature and an initial pressure;
b) a means for selecting a desired operating pressure;
c) at least one device for measuring temperature of a cryogenic liquid;
d) at least one device for measuring the cryogenic liquid depth inside the storage tank;
e) a means for controlling flow into the storage tank;
whereby flow into the storage tank is stopped at a calculated optimal fill level.
